(19) United States
(12) Patent Application Publication
(10) Pub. No.: US 2024/0430955 A1
(43) Pub. Date: Dec. 26, 2024

(54) WIRELESS NETWORK DEVICE AND SIGNAL TRANSMISSION METHOD

(71) Applicant: REALTEK SEMICONDUCTOR CORPORATION, Hsinchu (TW)

(72) Inventors: LI-KUAN CHEN, Hsinchu (TW); CHIA-YU HSU, Hsinchu (TW); JHE-YI LIN, Hsinchu (TW)

(21) Appl. No.: 18/741,893

(22) Filed: Jun. 13, 2024

(30) Foreign Application Priority Data
Jun. 20, 2023 (TW) 112123252

(51) Int. Cl. H04W 74/0833; H04W 74/08; H04W 76/20

(52) U.S. Cl. CPC H04W 74/085; H04W 74/0866; H04W 76/20

(57) ABSTRACT

A signal transmission method includes the following operations: selectively enabling a first backoff timer based on a spatial reuse condition when a channel on a transmission medium is in a busy state; selectively enabling a second backoff timer when the channel on the transmission medium switches from the busy state to an idle state; and controlling a transmitter circuit to transmit a data signal through the transmission medium based on a corresponding timer of the first backoff timer and the second backoff timer, in which when the corresponding timer is the first backoff timer, the transmitter circuit is controlled to transmit the data signal at first power, and when the corresponding timer is the second backoff timer, the transmitter circuit is controlled to transmit the data signal at second power, and the first power is lower than the second power.

### BACKGROUND OF THE INVENTION

### 1. Field of the Invention

The present disclosure relates to a wireless network device, especially to a wireless network device and a signal transmission method that are able to increase the opportunity of utilizing a spatial reuse mechanism for data transmission.

### 2. Description of Related Art

The IEEE 802.11ax standard proposes a spatial reuse mechanism aimed at increasing the throughput of data transmission and reducing transmission delay. In practical applications, if packets with shorter transmission times contends for the same channel on the transmission medium, the data transmission of the spatial reuse mechanism may not be executed, resulting in the improvement effects of the above mechanism not being significant. On the other hand, in existing approaches, devices utilizing the spatial reuse mechanism may have a higher probability of winning the channel contention during non-spatial reuse periods, which violates the random backoff mechanism defined in current standards.

### SUMMARY OF THE INVENTION

In some aspects, an object of the present disclosure is to, but not limited to, provide a wireless network device and a signal transmission method that are able to increase the opportunity of utilizing a spatial reuse mechanism for data transmission.

In some aspects, a wireless network device includes a transmitter circuit and a controller circuitry. The controller circuitry is configured to selectively enable a first backoff timer according to a spatial reuse condition when a channel on a transmission medium is in a busy state, and selectively enable a second backoff timer when the transmission medium switches from the busy state to an idle state, and control the transmitter circuit to transmit a data signal through the transmission medium based on a corresponding timer of the first backoff timer and the second backoff timer. When the corresponding timer is the first backoff timer, the controller circuitry controls the transmitter circuit to transmit the data signal at first power, and when the corresponding timer is the second backoff timer, the controller circuitry controls the transmitter circuit to transmit the data signal at second power, and the first power is lower than the second power.

In some aspects, a signal transmission method includes the following operations: selectively enabling a first backoff timer based on a spatial reuse condition when a channel on a transmission medium is in a busy state; selectively enabling a second backoff timer when the channel on the transmission medium switches from the busy state to an idle state; and controlling a transmitter circuit to transmit a data signal through the transmission medium based on a corresponding timer of the first backoff timer and the second backoff timer, in which when the corresponding timer is the first backoff timer, the transmitter circuit is controlled to transmit the data signal at first power, and when the corresponding timer is the second backoff timer, the transmitter circuit is controlled to transmit the data signal at second power, and the first power is lower than the second power.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a schematic diagram of a network system according to some embodiments of the present disclosure.

FIG. 2 illustrates a schematic diagram of the wireless network device in FIG. 1 according to some embodiments of the present disclosure.

FIG. 3A illustrates a schematic diagram of the operational behavior of the wireless network device in FIGS. 1 and 2 under a first scenario according to some embodiments of the present disclosure.

FIG. 3B illustrates a schematic diagram of the operational behavior of the wireless network device in FIGS. 1 and 2 under a second scenario according to some embodiments of the present disclosure.

FIG. 3C illustrates a schematic diagram of the operational behavior of the wireless network device in FIGS. 1 and 2 under a third scenario according to some embodiments of the present disclosure.

FIG. 3D illustrates a schematic diagram of the operational behavior of the wireless network device in FIGS. 1 and 2 under a fourth scenario according to some embodiments of the present disclosure.

FIG. 3E illustrates a schematic diagram of the operational behavior of the wireless network device in FIGS. 1 and 2 under a fifth scenario according to some embodiments of the present disclosure.

FIG. 4 illustrates a flowchart of a signal transmission method according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuitry” may indicate a system implemented with at least one circuit, and the term “circuit” may indicate an object, which is formed with one or more transistors and/or one or more active/passive elements based on a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, similar/identical elements in various figures are designated with the same reference number.

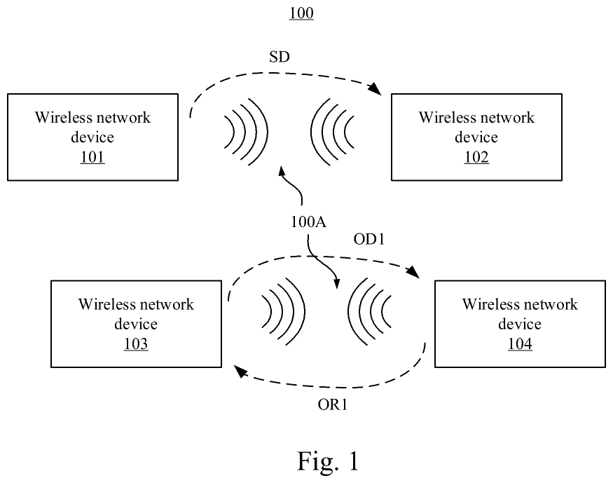

FIG. 1 illustrates a schematic diagram of a network system 100 according to some embodiments of the present disclosure. In this example, the network system 100 includes wireless network devices 101-104 that utilize channels on a transmission medium 100A to perform data transmission. The wireless network device 101 and the wireless network device 102 form a basic service set (BSS), and the wireless network device 103 and the wireless network device 104 form another BSS. For example, the wireless network device 101 operates as a station, the wireless network device 102 operates as an access point, and the wireless network device 101 and the wireless network device 102 may exchange data (e.g., as a data signal SD) through channels on the transmission medium 100A. Similarly, the wireless network device 103 operates as another station, the wireless network device 104 operates as another access point, and the wireless network device 103 and the wireless network device 104 may exchange data (e.g., a data signal OD1 and a response OR1) through channels on the transmission medium 100A. In some embodiments, the transmission medium 100A may be, but is not limited to, air.

In other words, in the example shown in FIG. 1, the coverage areas of two BSSs formed by the wireless network devices 101-104 are partially or completely overlapped with each other, resulting in overlapping basic service sets (OBSS). That is, in the same environment, the wireless network device 101 and the wireless network device 102 forms an OBSS corresponding to the wireless network device 103 and the wireless network device 104, and vice versa. When the coverage areas of these BSSs are overlapped with each other, data transmissions of the BSSs may collide and interfere with each other, resulting in a reduction in the overall transmission performance of the network system 100. In some embodiments, based on the carrier sense multiple access with collision avoidance (CSMA/CA) and spatial reuse (SR) mechanisms proposed in the IEEE 802.11 standards, the wireless network devices 101-104 may significantly reduce collision and interference in the same environment, thus enhancing overall transmission performance and stability. In some embodiments, based on the above mechanisms, the wireless network devices 101 and 102 may employ backoff timers as described below to increase the opportunity of using the SR mechanism to transmit data, thereby additionally improving transmission performance.

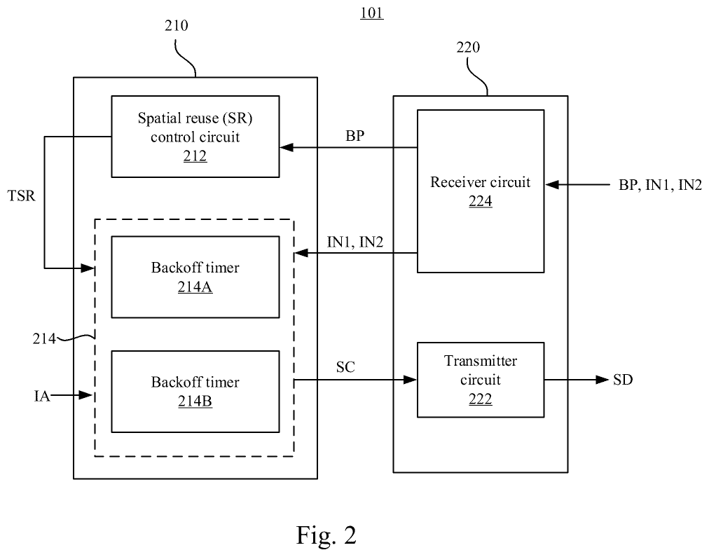

FIG. 2 illustrates a schematic diagram of the wireless network device 101 in FIG. 1 according to some embodiments of the present disclosure. In some embodiments, the configuration of other wireless network devices 102-104 in FIG. 1 may be identical to or different from the configuration shown in FIG. 2. For example, in some embodiments, each of the wireless network devices 102-104 may not include backoff timers. As shown in FIG. 2, the wireless network device 101 includes a controller circuitry 210 and a transceiver circuitry 220. The transceiver circuitry 220 includes a transmitter circuit 222 and a receiver circuit 224. The receiver circuit 224 may receive a packet BP from the OBSS (for example, the wireless network devices 103 and/or 104 in FIG. 1) through the transmission medium 100A of FIG. 1. The transmitter circuit 222 may transmit a data signal SD to the wireless network device 102 in FIG. 1 through the transmission medium 100A according to the control signal SC generated from the controller circuitry 210. In some embodiments, the transmitter circuit 222 includes a gain adjustment mechanism, which may adjust an amplification gain according to the control signal SC to adjust the output power of the data signal SD. Thus, the transmitter circuit 222 may transmit the data signal SD at first power or second power according to the corresponding timer.

The controller circuitry 210 may further receive clear channel assessment (CCA) information IA, intra-BSS network allocation vector (NAV) IN1 sent from the wireless network device 102, and inter-BSS NAV IN2 sent from the OBSS (e.g., the wireless network devices 103 and/or 104 in FIG. 1), and selectively enables a backoff timer 214A (corresponding to the SR mechanism as mentioned above) and/or a backoff timer 214B (corresponding to a general backoff mechanism) according to the CCA information IA, the packet BP, the intra-BSS NAV IN1, and the inter-BSS NAV IN2, in order to control the transmitter circuit 222 to transmit the signal SD at specific power.

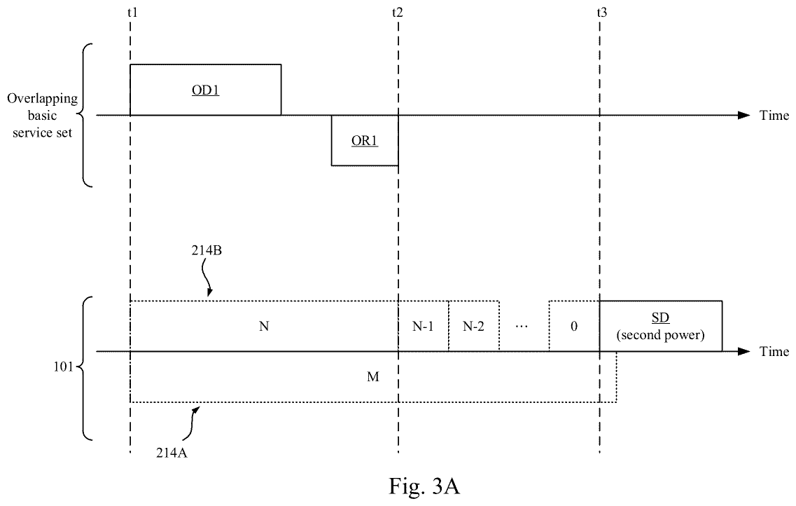

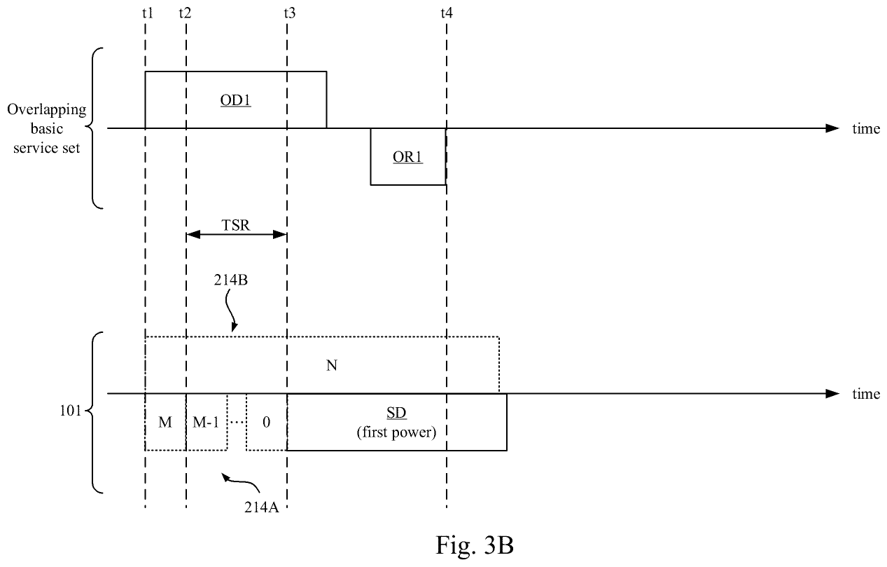

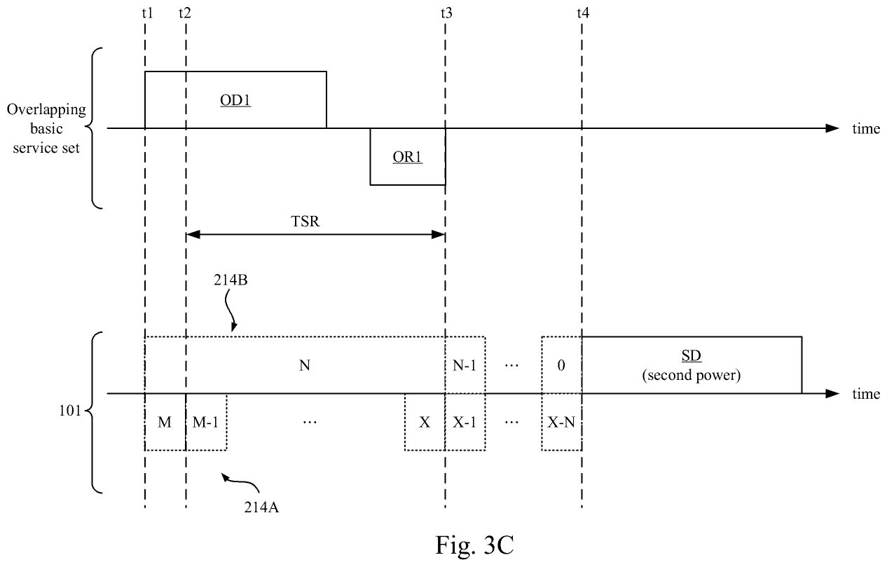

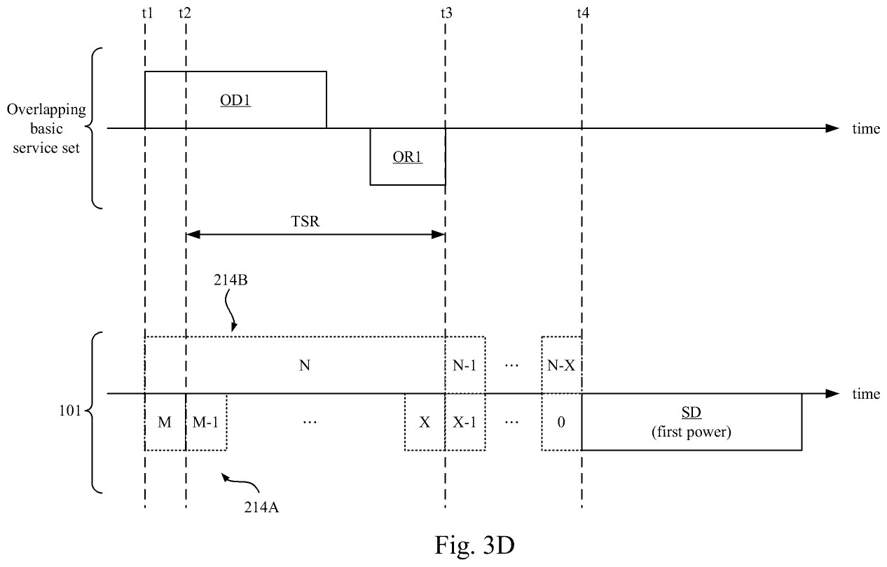

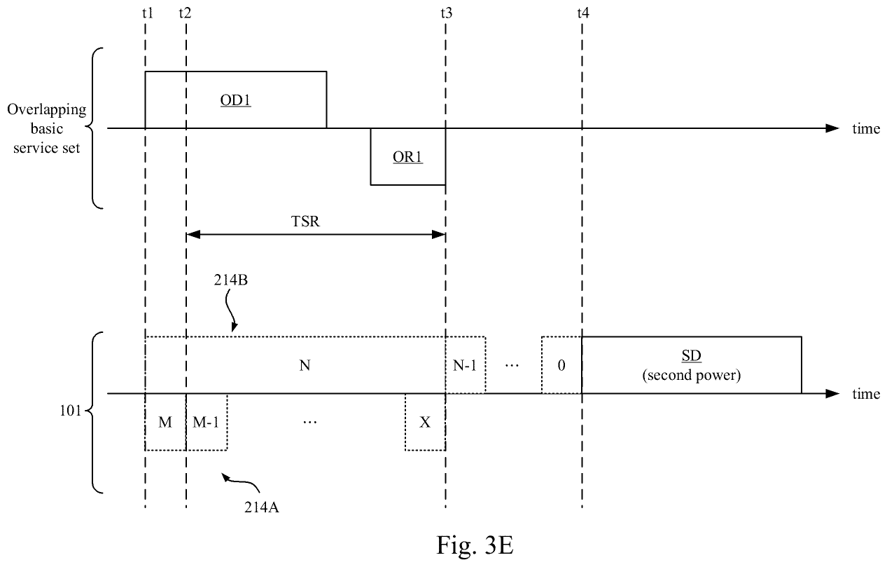

In greater detail, when the transmission medium 100A is in a busy state in response to the data transmission of the OBSS, the controller circuitry 210 may selectively enable the backoff timer 214A according to a SR condition. When the transmission medium 100A switches from the busy state to an idle state, the controller circuitry 210 may selectively enable the backoff timer 214B. Thus, the controller circuitry 210 may control the transmitter circuit 222 to transmit the data signal SD through the transmission medium 100A according to a corresponding timer of the backoff timers 214A and 214B. In some embodiments, when the OBSS (e.g., the wireless network devices 103 and/or 104 in FIG. 1) transmits data through channels on the transmission medium 100A, the channels on the transmission medium 100A is in the busy state. Under this condition, if the current transmission environment meets the SR condition, the controller circuitry 210 may enable the backoff timer 214A, thereby controlling the transmitter circuit 222 to transmit the data signal SD at the first power through the transmission medium 100A according to the backoff timer 214A (if the backoff timer 214A expires first). In other words, the wireless network device 101 may transmit data simultaneously with the OBSS through channels on the transmission medium 100A. Alternatively, when the data transmission by the OBSS through channels on the transmission medium 100A is completed, the transmission medium 100A switches from the busy state to the idle state. Under this condition, the controller circuitry 210 may enable the backoff timer 214B, thereby controlling the transmitter circuit 222 to transmit the data signal SD at the second power through the transmission medium 100A according to the backoff timer 214B (if the backoff timer 214B expires first), in which the first power is lower than the second power. In some embodiments, when the transmitter circuit 222 transmits the data signal SD at the corresponding power of the first power or the second power, the signal power of the data signal SD is about equal to that corresponding power. Details regarding herein will be further given with reference to FIGS. 3A-3E.

In some embodiments, the controller circuitry 210 may include a SR control circuit 212 and an enhanced distributed channel access function (EDCAF) control circuit 214. The SR control circuit 212 receives packet BP and measures the power of the received packet BP, and determines a SR period TSR accordingly. In some embodiments, the packet BP may be a protocol data unit (PDU) of the OBSS, which may include, but is not limited to, information such as the physical layer convergence procedure (PLCP) header, media access control (MAC) header, payload, and so on.

In some embodiments, based on the IEEE 802.11 standards (which may include, but not limited to, the IEEE 802.11ax standard or its successors), the SR control circuit 212 may determine whether the transmission medium 100A is in the busy state in response to the data transmission of the OBSS, or has switched to the idle state due to the completion of data transmission by the OBSS, according to the aforementioned information and the power of the packet BP, and may thus determine the SR period TSR. In some embodiments, the SR period TSR indicates a time interval from when the SR condition is detected to be met to when the SR mechanism starts transmitting the data signal SD, or the time from when the SR condition is detected to be met to when the data signal transmission by the OBSS is completed (which may be, as an example but not limited to the time when a response is received from the receiver end device, in which the response is to notify the transmitter end device that the transmission of the data signal has been completed). In some embodiments, based on the IEEE 802.11 standards mentioned above, the SR control circuit 212 may determine whether the SR condition is met by the current transmission environment according to the aforementioned information and the power of the packet BP, in order to determine whether to enable the backoff timer 214A corresponding to the SR mechanism. If the SR condition is met, it indicates that the controller circuitry 210 may selectively control the transmitter circuit 222 to transmit the data signal SD based on the SR mechanism. In some embodiments, the requirements for meeting the SR condition may be understood with reference to the aforementioned IEEE 802.11 standards, and thus not further elaborated herein. When the controller circuitry 210 detects that the SR condition is met, the controller circuitry 210 may selectively enable the backoff timer 214A. Alternatively, after the SR period TSR ends, the controller circuitry 210 may selectively enable the backoff timer 214B.

The EDCAF control circuit 214 may selectively enable a corresponding one of the backoff timer 214A or the backoff timer 214B according to the SR period TSR, the CCA information IA, the intra-BSS NAV IN1, and the inter-BSS NAV IN2, and sends the control signal SC according to the corresponding timer, in order to control the transmitter circuit 222 to transmit the data signal SD at the corresponding power. In some embodiments, the CCA information IA may be provided from other circuits (not shown) in the controller circuitry 210. In some embodiments, the CCA information IA may be obtained by measuring the energy on the channels of the transmission medium 100A. If the measured value is higher than a predetermined value, the CCA information IA may indicate that the channels on the transmission medium 100A is in the busy state. Alternatively, if the measured value is not higher than the predetermined value, the CCA information IA may indicate that the channels on the transmission medium 100A may be in the idle state.

In some embodiments, the intra-BSS NAV IN1 may indicate signal transmission by another device in the same BSS (e.g., the wireless network device 102 in FIG. 1), which may utilize a timer to avoid transmission at the same time as other devices, in order to prevent collisions and interference. In some embodiments, the inter-BSS NAV IN2 may indicate signal transmission by devices in the OBSS (e.g., the wireless network devices 103 and/or 104 in FIG. 1), which may also utilize a timer to avoid simultaneous transmissions with other devices to prevent collisions and interference. In some embodiments, if the value of the inter-BSS NAV IN2 or that of the intra-BSS NAV IN1 is not a predetermined value (which may be, but not limited to, 0), it indicates that other devices in the same BSS or the OBSSs are currently transmitting data or signals on the channels of the transmission medium 100A. Under these conditions, the EDCAF control circuit 214 may not enable the backoff timer 214A. After the SR period TSR, according to the state of the backoff timer 214A, the EDCAF control circuit 214 may selectively enable the backoff timer 214B and generate the control signal SC based on a corresponding timer that expires first in the backoff timers 214A and 214B, in order to control the transmitter circuit 222 to transmit the data signal SD at the corresponding power through the transmission medium 100A.

In some embodiments, the controller circuitry 210 may be implemented with at least one digital circuit that executes a driver program and/or software or algorithms related to the aforementioned communication standards. For example, the SR control circuit 212 may be implemented with software and/or hardware and processing circuits executing the SR mechanism in the IEEE 802.11ax standard, and the EDCAF control circuit 214 may be implemented with software and/or hardware and processing circuits executing the distributed channel access mechanism in the IEEE 802.11ax standard, but the present disclosure is not limited thereto. In some embodiments, each of the backoff timers 214A and 214B may be a virtual countdown timer, which may be implemented via software or a combination of software and hardware, and set with a random value (e.g., random values M and N mentioned later) by the aforementioned driver program and/or algorithms.

FIG. 3A illustrates a schematic diagram of the operational behavior of the wireless network device 101 in FIGS. 1 and 2 under a first scenario according to some embodiments of the present disclosure. In the first scenario, the current environment does not meet the SR condition, such that the controller circuitry 210 does not enable the backoff timer 214A.

In some embodiments, the backoff timer 214A may be selectively enabled during the SR period TSR and start counting down from the random value M to 0. In some embodiments, the backoff timer 214B may be selectively enabled after the SR period TSR and start counting down from the random value N to 0. Each of the random values M and N may be a positive integer greater than 0. After the backoff timer 214A expires (i.e., counts down to 0), the controller circuitry 210 may selectively output the control signal SC according to a corresponding one that expires first of the backoff timers 214A and 214B, in order to control the transmitter circuit 222 to transmit the data signal SD at the corresponding power.

As shown in FIG. 3A, at time t1, a device in the OBSS (e.g., the wireless network device 103 in FIG. 1) transmits a data signal OD1 to another device in the OBSS (e.g., the wireless network device 104 in FIG. 1). Under this condition, the SR control circuit 212 may obtain that the channels on the transmission medium 100A are in the busy state at time t1. At time t2, the other device in the OBSS has received the data signal OD1 and has completed transmitting the response OR1 to the device in the OBSS. Under this condition, as the data transmission of the OBSS has been completed, the channels on the transmission medium 100A switch from the busy state to the idle state. As previously mentioned, in the first scenario, the controller circuitry 210 determines that the current environment does not meet the SR condition (i.e., the SR period TSR is 0), such that the controller circuitry 210 does not enable the backoff timer 214A. Therefore, the backoff timer 214A is disabled and does not start counting down.

On the other hand, after time t2, the controller circuitry 210 enables the backoff timer 214B based on the general backoff mechanism. Under this condition, the backoff timer 214B starts counting down from the random value N to 0. At time t3, the backoff timer 214B expires, and the controller circuitry 210 outputs the control signal SC based on the backoff timer 214B that expires first, in order to control the transmitter circuit 222 to transmit the data signal SD at the second power (higher than the first power) through the transmission medium 100A to the wireless network device 102 in FIG. 1. From FIG. 3A, it is understood that, in this example, after the data transmission of the OBSS with the transmission medium 100A is completed, the transmitter circuit 222 may start transmitting the data signal SD at the second power (i.e., time t3). As a result, it is able to avoid the transmission between the wireless network device 101 and the wireless network device 102 being affected by the OBSS.

FIG. 3B illustrates a schematic diagram of the operational behavior of the wireless network device 101 in FIGS. 1 and 2 under a second scenario according to some embodiments of the present disclosure. In the second scenario, the current environment meets the SR condition, such that in the controller circuitry 210 enables the backoff timer 214A.

As shown in FIG. 3B, at time t1, a device in the OBSS (e.g., the wireless network device 103 in FIG. 1) transmits the data signal OD1 to another device in the OBSS (e.g., the wireless network device 104 in FIG. 1). Under this condition, the SR control circuit 212 may determine that the channels of the transmission medium 100A are in the busy state at time T1. At time t2, the controller circuitry 210 determines that the current environment meets the SR condition and thus enables the backoff timer 214A to start counting down from the random value M. At time t3, the backoff timer 214A expires, such that the controller circuitry 210 outputs the control signal SC based on the backoff timer 214A that expires first, in order to control the transmitter circuit 222 to transmit the data signal SD at the first power through the transmission medium 100A to the wireless network device 102 in FIG. 1. In other words, in the second scenario, the controller circuitry 210 controls the transmitter circuit 222 to transmit the data signal SD at a lower first power based on the SR mechanism. In this example, the period from time t2 to time t3 corresponds to the aforementioned SR period TSR.

At time t4, the other device in the OBSS has received the data signal OD1 and completed sending the response OR1 to a device. Under this condition, as the data transmission of the OBSS is completed, the channels on the transmission medium 100A switch from the busy state to the idle state. In the example of FIG. 3B, the controller circuitry 210 enables the backoff timer 214A, and the backoff timer 214A expires before the channels on the transmission medium 100A switch to the idle state (before time t4). Under this condition, as the controller circuitry 210 has already controlled the transmitter circuit 222 to transmit the data signal SD based on the first expired backoff timer 214A, the controller circuitry 210 does not enable the backoff timer 214B. On the other hand, from FIG. 3B, it is understood that, in this example, when the data transmission of the OBSS that utilizes the same transmission medium 100A is not yet completed and the channels on the transmission medium 100A continues to be in the busy due to the ongoing data transmission of the OBSS, the transmitter circuit 222 starts transmitting the data signal SD at the first power after time t3. In other words, in this example, OBSSs in the same environment (i.e., the wireless network devices 101-104 in FIG. 1) are able to simultaneously utilize the same transmission medium 100A for data transmission. As previously mentioned, as the transmitter circuit 222 transmits the data signal SD at the lower first power, the data transmission between the wireless network device 101 and the wireless network device 102 is less likely to affect the OBSS and may start transmitting the data signal SD earlier (compared with FIG. 3A) to improve data transmission efficiency.

FIG. 3C illustrates a schematic diagram of the operational behavior of the wireless network device 101 in FIGS. 1 and 2 under a third scenario according to some embodiments of the present disclosure. In the third scenario, both of the backoff timers 214A and 214B are enabled, and the backoff timer 214B expires first.

As shown in FIG. 3C, at time t1, a device in the OBSS (e.g., the wireless network device 103 in FIG. 1) transmits the data signal OD1 to another device in the OBSS (for example, the wireless network device 104 in FIG. 1). Under this condition, the SR control circuit 212 may determine that the channels of the transmission medium 100A are in the busy state at time t1. At time t2, the controller circuitry 210 determines that the current environment meets the SR condition, and accordingly enables the backoff timer 214A to start counting down from the random value M.

At time t3, the other device in the OBSS has received the data signal OD1 and completed sending the response OR1 to a device in the OBSS, and the backoff timer 214A has not yet expired (for example, it has counted down to a value X, in which the value X is greater than or equal to N). Under this condition, as the data transmission of the OBSS has been completed, the channels on the transmission medium 100A switch from the busy state to the idle state, such that the controller circuitry 210 enables the backoff timer 214B based on the general backoff mechanism. As a result, the backoff timer 214B starts counting down from the random value N to 0. In this example, the period from time t2 to time t3 corresponds to the aforementioned SR period TSR. At time t4, the backoff timer 214B expires while the backoff timer 214A has not yet expired, such that the controller circuitry 210 outputs the control signal SC based on the backoff timer 214B that expires first, in order to control the transmitter circuit 222 to transmit the data signal SD at the second power through the transmission medium 100A.

Similar to FIG. 3A, in this example, when the transmitter circuit 222 transmits the data signal SD at the second power (after time t4), the data transmission of the OBSS that utilize the same transmission medium 100A has been completed. As a result, it is able to prevent the transmission between the wireless network device 101 and the wireless network device 102 from being affected by the OBSS.

FIG. 3D illustrates a schematic diagram of the operational behavior of the wireless network device 101 in FIGS. 1 and 2 under a fourth scenario according to some embodiments of the present disclosure. In the fourth scenario, both of the backoff timers 214A and 214B are enabled, and the backoff timer 214A expires first.

As shown in FIG. 3D, at time t1, a device in the OBSS (e.g., the wireless network device 103 in FIG. 1) transmits the data signal OD1 to another device in the OBSS (e.g., the wireless network device 104 in FIG. 1). Under this condition, the SR control circuit 212 may determine that the channels of the transmission medium 100A are in the busy state at time t1. At time t2, the controller circuitry 210 determines that the current environment meets the SR condition, and accordingly enables the backoff timer 214A to start counting down from the random value M.

At time t3, the other device in the OBSS has received the data signal OD1 and completed sending the response OR1 to a device in the OBSS, and the backoff timer 214A has not yet expired (it has counted down to the value X, where X is less than N). Under this condition, as the data transmission of the OBSS has been completed, the channels on the transmission medium 100A switch from the busy state to the idle state, such that the controller circuitry 210 enables the backoff timer 214B based on the general backoff mechanism. As a result, the backoff timer 214B starts counting down from the random value N to N-X. At time t4, the backoff timer 214A expires while the backoff timer 214B has not yet expired, such that the controller circuitry 210 outputs the control signal SC based on the backoff timer 214A that expires first, in order to control the transmitter circuit 222 to transmit the data signal SD at the first power through the transmission medium 100A.

Different from FIG. 3B, in this example, the transmitter circuit 222 starts transmitting the data signal SD at the first power after the data transmission by the OBSS that utilizes the same transmission medium 100A is completed (i.e., at time t4). From FIGS. 3B and 3D, it is understood that when the controller circuitry 210 outputs the control signal SC based on the backoff timer 214A, in order to control the transmitter circuit 222 to transmit the data signal SD at the lower first power, the channels on the transmission medium 100A may continue to be in the busy state based on the data transmission of the OBSS (as shown in FIG. 3B), or may be in the idle state (as shown in FIG. 3D). In other words, when the data signal SD is transmitted through the SR mechanism, the data transmission of the wireless network device 101 is not limited by the operational state of the channels on the transmission medium 100A.

FIG. 3E illustrates a schematic diagram of the operational behavior of the wireless network device 101 in FIGS. 1 and 2 under a fifth scenario according to some embodiments of the present disclosure. In the fifth scenario, the backoff timer 214A is enabled but stops counting down at the end of the SR period TSR.

As shown in FIG. 3E, at time t1, a device in the OBSS (e.g., the wireless network device 103 in FIG. 1) transmits the data signal OD1 to another device in the OBSS (e.g., the wireless network device 104 in FIG. 1). Under this condition, the SR control circuit 212 may determine that the channels of the transmission medium 100A are in the busy state at time T1. At time t2, the controller circuitry 210 determines that the current environment meets the SR condition, and accordingly enables the backoff timer 214A to start counting down from the random value M.

At time t3, the other device in the OBSS has received the data signal OD1 and completed sending the response OR1 to the device in the OBSS, and the backoff timer 214A has not yet expired (it has counted down to the value X). However, the controller circuitry 210 may determine that the channel utilization rate of the wireless network device 101 after time t3 is significantly higher than that of other devices based on previous statistics on transmission, and thus control the backoff timer 214A to stop counting down to ensure fairness in channel usage. In other words, in some embodiments, the controller circuitry 210 may selectively stop the backoff timer 214A based on the channel utilization rate of the transmitter circuit 222. Thus, when the controller circuitry 210 determines that the channel utilization rate of its own device (e.g., the transmitter circuit 222) is too high, the controller circuitry 210 may only utilize the backoff timer 214B for subsequent channel contention. In some embodiments, the controller circuitry 210 may execute a predetermined algorithm during transmission to calculate the aforementioned channel utilization rate. For example, the wireless network device 101 may detect whether the wireless network devices that utilize the channel belong to the same BSS over a period (e.g., at multiple time points), in order to calculate the ratio of the channel usage time of the OBSS to its own (or its BSS) channel usage time, thereby determining if its own (or its BSS) channel utilization rate is too high. On the other hand, at time t3, as the data transmission of the OBSS has been completed, the channels on the transmission medium 100A switch from the busy state to the idle state, such that the controller circuitry 210 enables the backoff timer 214B based on the general backoff mechanism. As a result, the backoff timer 214B starts counting down from the random value N to 0. At time t4, the backoff timer 214B expires, such that the controller circuitry 210 outputs the control signal SC based on the expired backoff timer 214B, in order to control the transmitter circuit 222 to start transmitting the data signal SD at the second power through the transmission medium 100A.

In the scenarios described above, depending on the data transmission of another OBSS in the application environment and/or operational conditions in the environment, the controller circuitry 210 may selectively enable the backoff timer 214A corresponding to the SR mechanism or the backoff timer 214B corresponding to the general backoff mechanism, and generate the control signal SC based on the one of these two backoff timers that expires first, in order to control the transmitter circuit 222 to transmit the data signal SD at the corresponding power. With the above control mechanism, the wireless network device 101 is able to increase the opportunity to transmit the data signal SD with the SR mechanism, without violating the original backoff mechanism, to comply with the requirements of existing communication standards.

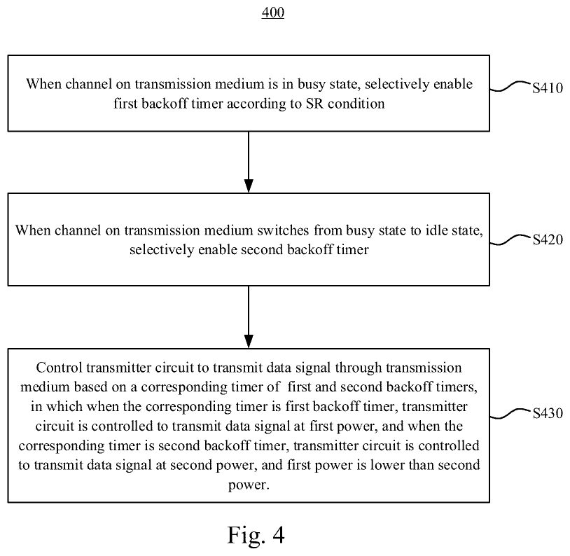

FIG. 4 illustrates a flowchart of a signal transmission method 400 according to some embodiments of the present disclosure. In operation S410, when a channel on a transmission medium is in a busy state, a first backoff timer is selectively enabled according to a SR condition. In operation S420, when the channel on the transmission medium switches from the busy state to an idle state, a second backoff timer is selectively enabled. In operation S430, a transmitter circuit is controlled to transmit a data signal through the transmission medium based on the corresponding timer of the first and second backoff timers, in which when the corresponding timer is the first backoff timer, the transmitter circuit is controlled to transmit the data signal at first power, and when the corresponding timer is the second backoff timer, the transmitter circuit is controlled to transmit the data signal at second power, and the first power is lower than the second power.

The above operations of the signal transmission method 400 can be understood with reference to above embodiments, and thus the repetitious descriptions are not further given. The above description of the signal transmission method 400 includes exemplary operations, but the operations of the signal transmission method 400 are not necessarily performed in the order described above. Operations of the signal transmission method 400 may be added, replaced, changed order, and/or eliminated, or the operations of the signal transmission method 400 may be executed simultaneously or partially simultaneously as appropriate, in accordance with the spirit and scope of various embodiments of the present disclosure.

As described above, the wireless network device and the signal transmission method provided in some embodiments of the present disclosure can selectively utilize the SR mechanism for transmitting data signals based on the data transmission of the OBSS and operational conditions in the current environment. As a result, the opportunity to utilize the SR mechanism is increased while complying with the original rules of the current existing communication standards, and the efficiency of data transmission is further improved.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely some embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. A wireless network device, comprising:
a transmitter circuit; and
a controller circuitry configured to selectively enable a first backoff timer according to a spatial reuse condition when a channel on a transmission medium is in a busy state, and selectively enable a second backoff timer when the transmission medium switches from the busy state to an idle state, and control the transmitter circuit to transmit a data signal through the transmission medium based on a corresponding timer of the first backoff timer and the second backoff timer,
wherein when the corresponding timer is the first backoff timer, the controller circuitry controls the transmitter circuit to transmit the data signal at first power, and when the corresponding timer is the second backoff timer, the controller circuitry controls the transmitter circuit to transmit the data signal at second power, and the first power is lower than the second power.

2. The wireless network device of claim 1, wherein the channel on the transmission medium is in the busy state due to a data transmission of an overlapping basic service set, and after the data transmission is completed, the transmitter circuit starts transmitting the data signal at the second power.

3. The wireless network device of claim 1, wherein when the controller circuitry enables the first backoff timer and the first backoff timer expires before the channel on the transmission medium switches to the idle state, the controller circuitry does not enable the second backoff timer.

4. The wireless network device of claim 1, wherein when the controller circuitry determines that the spatial reuse condition is not met, the controller circuitry does not enable the first backoff timer.

5. The wireless network device of claim 1, wherein the channel on the transmission medium is in the busy state due to a data transmission of an overlapping basic service set, and when the data transmission has not yet been completed and the channel on the transmission medium continues to be in the busy state due to the data transmission of the overlapping basic service set, the transmitter circuit starts transmitting the data signal at the first power.

6. The wireless network device of claim 1, wherein the channel on the transmission medium is in the busy state due to a data transmission in an overlapping basic service set, and after the data transmission is completed, the transmitter circuit starts transmitting the data signal at the first power.

7. The wireless network device of claim 1, wherein the controller circuitry is further configured to selectively stop the first backoff timer based on a channel utilization rate of the transmitter circuit.

8. The wireless network device of claim 1, wherein the corresponding timer is a timer of the first backoff timer and the second backoff timer that expires first.

9. The wireless network device of claim 1, wherein the first backoff timer corresponds to a spatial reuse mechanism.

10. The wireless network device of claim 1, wherein the channel on the transmission medium is in the busy state due to a data transmission of an overlapping basic service set, and the controller circuitry is configured to determine whether the spatial reuse condition is met according to a packet transmitted from the overlapping basic service set, in order to selectively enable the first backoff timer.

11. A signal transmission method, comprising:
selectively enabling a first backoff timer based on a spatial reuse condition when a channel on a transmission medium is in a busy state;
selectively enabling a second backoff timer when the channel on the transmission medium switches from the busy state to an idle state; and
controlling a transmitter circuit to transmit a data signal through the transmission medium based on a corresponding timer of the first backoff timer and the second backoff timer,
wherein when the corresponding timer is the first backoff timer, the transmitter circuit is controlled to transmit the data signal at first power, and when the corresponding timer is the second backoff timer, the transmitter circuit is controlled to transmit the data signal at second power, and the first power is lower than the second power.

12. The signal transmission method of claim 11, wherein the channel on the transmission medium is in the busy state due to a data transmission of an overlapping basic service set, and after the data transmission is completed, the transmitter circuit is controlled to start transmitting the data signal at the second power.

13. The signal transmission method of claim 11, wherein when the first backoff timer is enabled and expires before the channel on the transmission medium switches to the idle state, the second backoff timer is not enabled.

14. The signal transmission method of claim 11, wherein when the spatial reuse condition is not met, the first backoff timer is not enabled.

15. The signal transmission method of claim 11, wherein the channel on the transmission medium is in the busy state due to a data transmission of an overlapping basic service set, and when the data transmission has not yet been completed and the channel on the transmission medium continues to be in the busy state due to the data transmission of the overlapping basic service set, the transmitter circuit is controlled to start transmitting the data signal at the first power.

16. The signal transmission method of claim 11, wherein the channel on the transmission medium is in the busy state due to a data transmission in an overlapping basic service set, and after the data transmission is completed, the transmitter circuit starts transmitting the data signal at the first power.

17. The signal transmission method of claim 11, further comprising:
selectively stopping the first backoff timer based on a channel utilization rate of the transmitter circuit.

18. The signal transmission method of claim 11, wherein the corresponding timer is a timer of the first backoff timer and the second backoff timer that expires first.

19. The signal transmission method of claim 11, wherein the first backoff timer corresponds to a spatial reuse mechanism.

20. The signal transmission method of claim 11, wherein the channel on the transmission medium is in the busy state due to a data transmission of an overlapping basic service set, and selectively enabling the first backoff timer based on the spatial reuse condition when the channel on the transmission medium is in the busy state comprises:
determining whether the spatial reuse condition is met according to a packet transmitted from the overlapping basic service set, in order to selectively enable the first backoff timer.
